(19) United States
(12) Patent Application Publication
(10) Pub. No.: US 2016/0148254 A1
(43) Pub. Date: May 26, 2016

(54) DYNAMIC CONTENT INSERTION METHOD AND SYSTEM

(71) Applicant: Intel Corporation, Santa Clara, WA (US)

(72) Inventors: Chris HOUTZER, Seattle, WA (US); Garrett LINK, Seattle, WA (US)

(21) Appl. No.: 14/832,795

(22) Filed: Aug. 21, 2015

Related U.S. Application Data
(63) Continuation of application No. 11/745,617, filed on May 8, 2007, now abandoned.

(51) Int. Cl. G06Q 30/02; H04M 1/725

(52) U.S. Cl. CPC G06Q 30/0252; G06Q 30/0277; G06Q 30/0267; H04M 1/72544

(57) ABSTRACT

A method and computer program product for initializing an event timer. A first portion of a computer application is executed. After completion of the execution of the first portion of the computer application, it is determined if the event timer has reached a predetermined amount. If the event timer has reached the predetermined amount, a first advertisement is rendered.

### TECHNICAL FIELD

This disclosure relates to dynamic content insertion and, more particularly, to dynamic content insertion in computer applications.

### BACKGROUND

Gaming websites (e.g., www.gamehouse.com) allow users to play online games and/or download games for playing on local computing devices. However, users are often apprehensive to purchase games that they have not yet played. Accordingly, gaming websites often allow users to sample the game prior to being required to purchase the game.

For example, the user may be allowed to download a trail version of a game, which allows the user to play the game for a defined period of time prior to being required to purchase the game. Unfortunately, these “free trial period” games have a notoriously low purchase rate (e.g., <2%).

Alternatively, some game websites and/or game producers have chosen to insert advertisements into games, thus allowing users to play the games for free. Unfortunately, these advertisements are typically inserted at predefined intervals (e.g., every 10 minutes), regardless of the status of the game play. For example, an advertisement may be inserted into a game during the middle of an action sequence, thus interrupting game play and frustrating the user.

### SUMMARY OF DISCLOSURE

In a first implementation, a method includes initializing an event timer. A first portion of a computer application is executed. After completion of the execution of the first portion of the computer application, it is determined if the event timer has reached a predetermined amount. If the event timer has reached the predetermined amount, a first advertisement is rendered.

One or more of the following features may be included. If the event timer has not reached the predetermined amount, a second portion of the computer application may be executed. In response to rendering the first advertisement, a second portion of the computer application may be rendered.

The computer application may be a gaming computer application. The first portion of the computer application may be a first level of the gaming computer application. The computer application may be a productivity computer application.

The first advertisement may be chosen from the group consisting of: a video advertisement; an audio advertisement; and a still image advertisement. An introductory advertisement may be rendered prior to initializing the event timer. If the event timer has reached the predetermined amount, the event timer may be reset.

In another implementation, a computer program product resides on a computer readable medium having a plurality of instructions stored on it. When executed by a processor, the computer program product causes the processor to perform operations including initializing an event timer. A first portion of a computer application is executed. After completion of the execution of the first portion of the computer application, it is determined if the event timer has reached a predetermined amount. If the event timer has reached the predetermined amount, a first advertisement is rendered.

One or more of the following features may be included. If the event timer has not reached the predetermined amount, a second portion of the computer application may be executed. In response to rendering the first advertisement, a second portion of the computer application may be executed.

The computer application may be a gaming computer application. The first portion of the computer application may be a first level of the gaming computer application. The computer application may be a productivity computer application.

The first advertisement may be chosen from the group consisting of: a video advertisement; an audio advertisement; and a still image advertisement. An introductory advertisement may be rendered prior to initializing the event timer. If the event timer has reached the predetermined amount, the event timer may be reset.

In another implementation, a method includes initializing an event timer. Execution of a multi-portion computer application is initiated. It is determined if the event timer has reached a predetermined amount. If the event timer has reached the predetermined amount, a first advertisement is rendered after completion of the execution of the current portion of the multi-portion computer application.

One or more of the following features may be included. In response to rendering the first advertisement, execution of the multi-portion computer application may be continued. The multi-portion computer application may be a gaming computer application. At least one portion of the multi-portion computer application may be a level of the gaming computer application. The multi-portion computer application may be a productivity computer application. The first advertisement may be chosen from the group consisting of: a video advertisement; an audio advertisement; and a still image advertisement.

An introductory advertisement may be rendered prior to initializing the event timer. If the event timer has reached the predetermined amount, the event timer may be reset.

In another implementation, a computer program product resides on a computer readable medium having a plurality of instructions stored on it. When executed by a processor, the computer program product causes the processor to perform operations including initializing an event timer. Execution of a multi-portion computer application is initiated. It is determined if the event timer has reached a predetermined amount. If the event timer has reached the predetermined amount, a first advertisement is rendered after completion of the execution of the current portion of the multi-portion computer application.

One or more of the following features may be included. In response to rendering the first advertisement, execution of the multi-portion computer application may be continued. The multi-portion computer application may be a gaming computer application. At least one portion of the multi-portion computer application may be a level of the gaming computer application. The multi-portion computer application may be a productivity computer application. The first advertisement may be chosen from the group consisting of: a video advertisement; an audio advertisement; and a still image advertisement.

An introductory advertisement may be rendered prior to initializing the event timer. If the event timer has reached the predetermined amount, the event timer may be reset.

In another implementation, a method includes initializing an event timer. A first portion of a gaming computer application is executed. After completion of the execution of the first portion of the gaming computer application, it is determined if the event timer has reached a predetermined amount. If the event timer has reached the predetermined amount, a first portion of dynamic content is rendered.

One or more of the following features may be included. If the event timer has not reached the predetermined amount, a second portion of the gaming computer application is executed. In response to rendering the first portion of dynamic content, a second portion of the gaming computer application is executed.

In another implementation, a computer program product resides on a computer readable medium having a plurality of instructions stored on it. When executed by a processor, the computer program product causes the processor to perform operations including initializing an event timer. A first portion of a gaming computer application is executed. After completion of the execution of the first portion of the gaming computer application, it is determined if the event timer has reached a predetermined amount. If the event timer has reached the predetermined amount, a first portion of dynamic content is rendered.

One or more of the following features may be included. If the event timer has not reached the predetermined amount, a second portion of the gaming computer application is executed. In response to rendering the first portion of dynamic content, a second portion of the gaming computer application is executed.

In another implementation, a method includes initializing an event timer. Execution of a multi-portion gaming computer application is initiated. It is determined if the event timer has reached a predetermined amount. If the event timer has reached the predetermined amount, a first portion of dynamic content is rendered after execution of the current portion of the multi-portion gaming computer application is completed.

One or more of the following features may be included. In response to rendering the first portion of dynamic content, execution of the multi-portion gaming computer application is continued.

In another implementation, a computer program product resides on a computer readable medium having a plurality of instructions stored on it. When executed by a processor, the computer program product causes the processor to perform operations including initializing an event timer. Execution of a multi-portion gaming computer application is initiated. It is determined if the event timer has reached a predetermined amount. If the event timer has reached the predetermined amount, a first portion of dynamic content is rendered after execution of the current portion of the multi-portion gaming computer application is completed.

One or more of the following features may be included. In response to rendering the first portion of dynamic content, execution of the multi-portion gaming computer application is continued.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a computer application and a content insertion process coupled to a distributed computing network;

FIG. 2 is a display screen rendered by the computer application of FIG. 1;

FIG. 3 is a display screen rendered by the computer application of FIG. 1;

FIG. 4 is a flowchart of a process executed by the content insertion process of FIG. 1;

FIG. 5 is a display screen rendered by the computer application of FIG. 1;

FIG. 6 is a display screen rendered by the computer application of FIG. 1;

FIG. 7 is a display screen rendered by the computer application of FIG. 1;

FIG. 8 is a display screen rendered by the computer application of FIG. 1; and

FIG. 9 is a flowchart of a process executed by the content insertion process of FIG. 1.

Like reference symbols in the various drawings indicate like elements.

### DETAILED DESCRIPTION OF THE PREFERRED EMBODIMENTS

### System Overview:

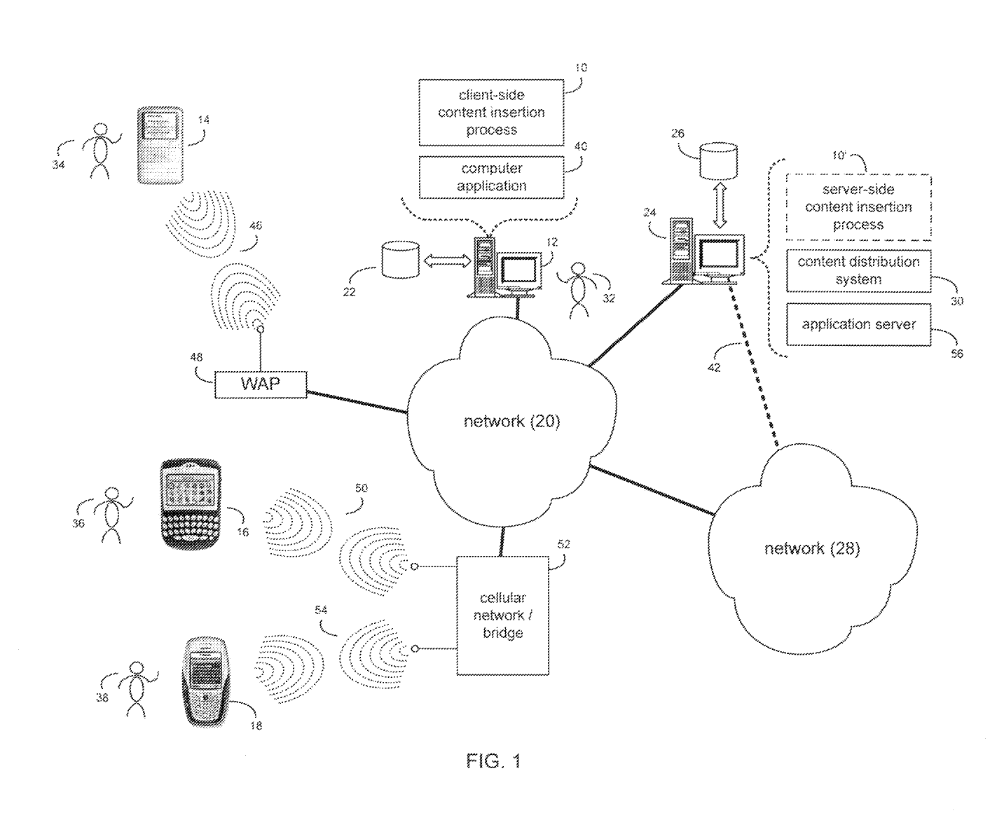

Referring to FIG. 1, there is shown a content insertion process 10 that may be resident on and executed by a client device. Examples of a client device may include but are not limited to client computer 12, personal media device 14, personal digital assistant 16, cellular telephone 18, laptop computers (not shown), televisions (not shown), cable boxes (not shown), internet radios (not shown), gaming consoles (e.g., a Sony Playstation™; not shown), portable gaming devices (e.g., a Sony PSP™; not shown); and/or dedicated network devices (not shown).

As will be discussed below in greater detail, content insertion process 10 may insert advertisements at various predefined content insertion points during the execution of a computer application.

Content insertion process 10 may be a client-side application that resides on and is executed by e.g., client computer 12, which may be connected to network 20 (e.g., the Internet). The instruction sets and subroutines of content insertion process 10, which may be stored on a storage device 22 coupled to client computer 12, may be executed by one or more processors (not shown) and one or more memory architectures (not shown) incorporated into client computer 12. Storage device 22 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, the above-described content insertion process may be a server-based application, as represented by content insertion process 10′ (shown in phantom). Content insertion process 10′ may reside on and may be executed by data server 24, which may be connected to network 20 (e.g., the Internet). Examples of data server 24 may include, but are not limited to: a personal computer, a server computer, a series of server computers, a mini computer, and a mainframe computer. Data server 24 may be a web server (or series of servers) running a network operating system, examples of which may include but are not limited to: Microsoft Windows XP Server™; Novell Netware™; or Redhat Linux™, for example.

Data server 24 may execute a web server application, examples of which may include but are not limited to: Microsoft IIS™, Novell Webserver™, or Apache Webserver™, that allows for HTTP (i.e., HyperText Transfer Protocol) access to data server 24 via network 20. Network 20 may be connected to one or more secondary networks (e.g., network 28), examples of which may include but are not limited to: a local area network; a wide area network; or an intranet, for example.

The instruction sets and subroutines of content insertion process 10′, which may be stored on storage device 26 coupled to data server 24, may be executed by one or more processors (not shown) and one or more memory architectures (not shown) incorporated into data server 24. Storage device 26 may include but is not limited to: a hard disk drive; a tape drive; an optical drive; a RAID array; a random access memory (RAM); a read-only memory (ROM) a compact flash (CF) storage device, a secure digital (SD) storage device, and a memory stick storage device.

As discussed above, the content insertion process may be a client-side application (e.g., client-side content insertion process 10), a server-side application (e.g., server-side content insertion process 10′), or a hybrid client-side/server-side application (e.g., using portions of both client-side content insertion process 10 and server-side content insertion process 10′).

Content distribution system 30 may provide advertisements to a plurality of users (e.g., users 32, 34, 36, 38). Content distribution system 30 may be a server application that resides on and is executed by data server 24. The instruction sets and subroutines of content distribution system 30, which may be stored on storage device 26 coupled to data server 24, may be executed by one or more processors (not shown) and one or more memory architectures (not shown) incorporated into data server 24.

Users 32, 34, 36, 38 may use a computer application executed on the client device they are using. For example, user 32 may use computer application 40 executed on client computer 12; and users 34, 36, 38 may use similar computer applications (not shown) executed on personal media device 14, personal digital assistant 16 and/or cellular telephone 18 (respectively). Additionally, other users (not shown) may use similar computer applications executed on laptop computers (not shown), televisions (not shown), cable boxes (not shown), internet radios (not shown), gaming consoles (e.g., a Sony Playstation™; not shown), portable gaming devices (e.g., a Sony PSP™; not shown); and/or dedicated network devices (not shown). Examples of computer application 40 may include: gaming computer applications (e.g., Cake Mania™ by Gamehouse, Inc. of Seattle, Wash.), and productivity computer applications (e.g., Microsoft Word™). Additionally, computer application 40 may be a web-browsing computer applications (e.g., Microsoft Internet Explorer™ and Mozilla Firefox™) that allow users to access and use remote “online” applications (e.g., online gaming applications and online productivity applications).

For the purpose of this disclosure, a gaming computer application is any computer application that is executed by a user (at least in part) for entertainment/educational purposes. For the purpose of this disclosure, a productivity computer application is any computer application that is executed by a user (at least in part) for productivity/work-related purposes. Accordingly and with respect to this disclosure, a single computer application may be both a gaming computer application and a productivity computer application.

Computer application 40 and/or other computer applications (not shown) executed on other client devices (e.g., personal media device 14, personal digital assistant 16 and/or cellular telephone 18, laptop computers (not shown), televisions (not shown), cable boxes (not shown), internet radios (not shown), gaming consoles (e.g., a Sony Playstation™; not shown), portable gaming devices (e.g., a Sony PSP™; not shown); and/or dedicated network devices (not shown)) may access server-side content insertion process 10′ and/or content distribution system 30 directly through network 20 or through secondary network 28. Further, data server 24 may be coupled to network 20 through secondary network 28, as illustrated with phantom link line 42.

The instruction sets and subroutines of computer application 40, which may be stored on a storage device 22 coupled to client computer 12, may be executed by one or more processors (not shown) and one or more memory architectures (not shown) incorporated into client computer 12. Storage device 22 may include but is not limited to: a hard disk drive; a tape drive; an optical drive; a RAID array; a random access memory (RAM); a read-only memory (ROM) a compact flash (CF) storage device, a secure digital (SD) storage device, and a memory stick storage device.

The various client devices may be directly or indirectly coupled to network 20 (or network 28). For example, client computer 12 is shown directly coupled to network 20 via a hardwired network connection. Alternatively, the client devices may be indirectly coupled to network 20 (or network 28). For example, personal media device 14 is shown wirelessly coupled to network 20 via wireless communication channel 46 established between personal media device 14 and wireless access point (i.e., WAP) 48, which is shown directly coupled to network 20. Further, personal digital assistant 16 is shown wirelessly coupled to network 20 via wireless communication channel 50 established between personal digital assistant 16 and cellular network/bridge 52, which is shown directly coupled to network 20. Further, cellular telephone 18 is shown wirelessly coupled to network 20 via wireless communication channel 54 established between cellular telephone 18 and cellular network/bridge 52, which is shown directly coupled to network 20.

WAP 48 may be, for example, an IEEE 802.11a, 802.11b, 802.11g, Wi-Fi, and/or Bluetooth device that is capable of establishing secure communication channel 46 between personal media device 14 and WAP 48.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Content Insertion Process:

As discussed above, client computer 12, personal media device 14, personal digital assistant 16, cellular telephone 18, laptop computers (not shown), televisions (not shown), cable boxes (not shown), internet radios (not shown), gaming consoles (e.g., a Sony Playstation™; not shown), portable gaming devices (e.g., a Sony PSP™; not shown), and/or dedicated network devices (not shown) may each execute a computer application (e.g., computer application 40), examples of which may include but are not limited to gaming computer applications, productivity computer applications, and web-browsing computer applications.

Client-side content insertion process 10 may be incorporated into (e.g., a portion of or a plug-in executed within) computer application 40 and may be configured to access content distribution system 30 through e.g., network 20 and/or network 28. Additionally/alternatively, computer application 40 may be configured to access server-side content insertion process 10′ and/or content distribution system 30 through e.g., network 20 and/or network 28.

Users 32, 34, 36, 38 may access application server 56, which may allow users to download computer applications (e.g., computer application 40) for installation on their respective client devices (e.g., client computer 12, personal media device 14, personal digital assistant 16, cellular telephone 18). Additionally/alternatively, users 32, 34, 36, 38 may use computer application 40 (e.g., a web-browsing application) to access online applications served by application server 56.

The instruction sets and subroutines of application server 56, which may be stored on a storage device 26 coupled to data server 24, may be executed by one or more processors (not shown) and one or more memory architectures (not shown) incorporated into data server 24.

As discussed above, examples of computer application 40 may include a locally-installed gaming/productivity application and/or a web-browsing application that allows access to computer applications remotely available via e.g., application server 56. For example, if computer application 40 is a locally-installed gaming computer application, user 32 may download computer application 40 from application server 56 and install computer application 40 on client computer 12. Alternatively, if computer application 40 is a web-browsing application, computer application 40 may allow user 12 to access and execute remotely-installed gaming/productivity computer application.

Regardless of whether computer application 40 is a locally-installed gaming/productivity computer application or a web-browsing computer application that allows access to a remotely-installed gaming/productivity computer application, content insertion process 10, 10′ may function in a similar fashion.

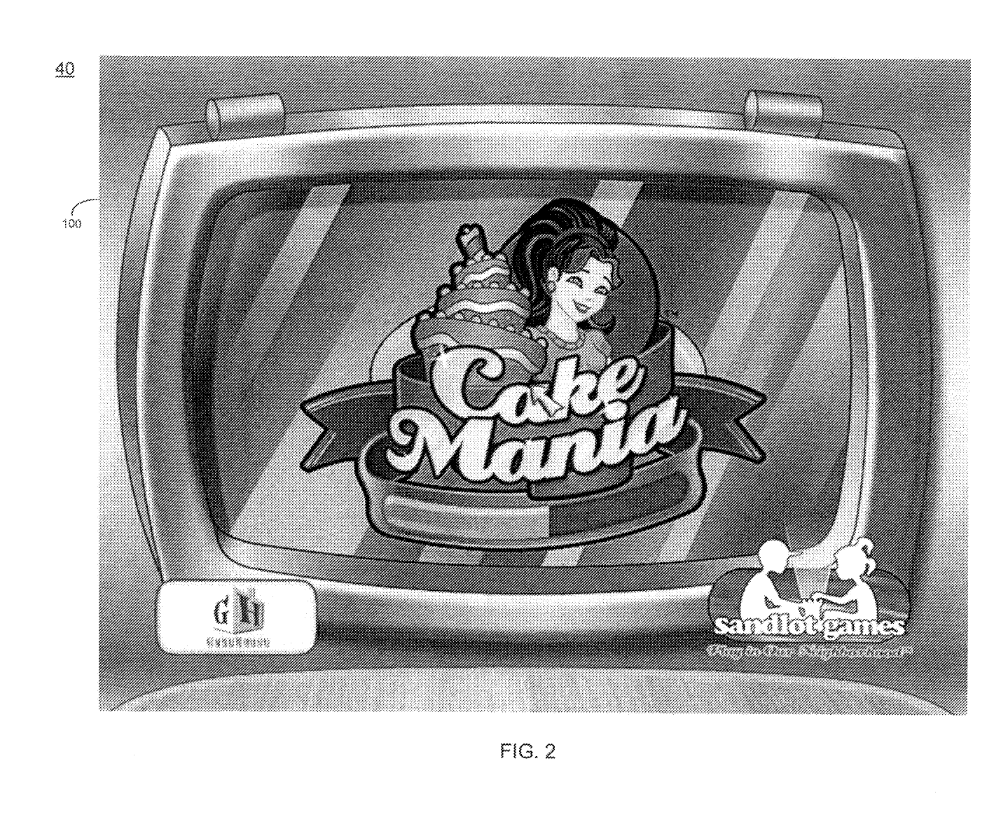

Referring also to FIG. 2, when initiating execution of computer application 40 (if a locally-executed application) or accessing a remotely-executed application (using computer application 40), splash screen 100 may be rendered by computer application 40. In this particular example, splash screen 100 is the introductory screen of the Cake Mania™ gaming computer application offered by Game House Inc. of Seattle, Wash.

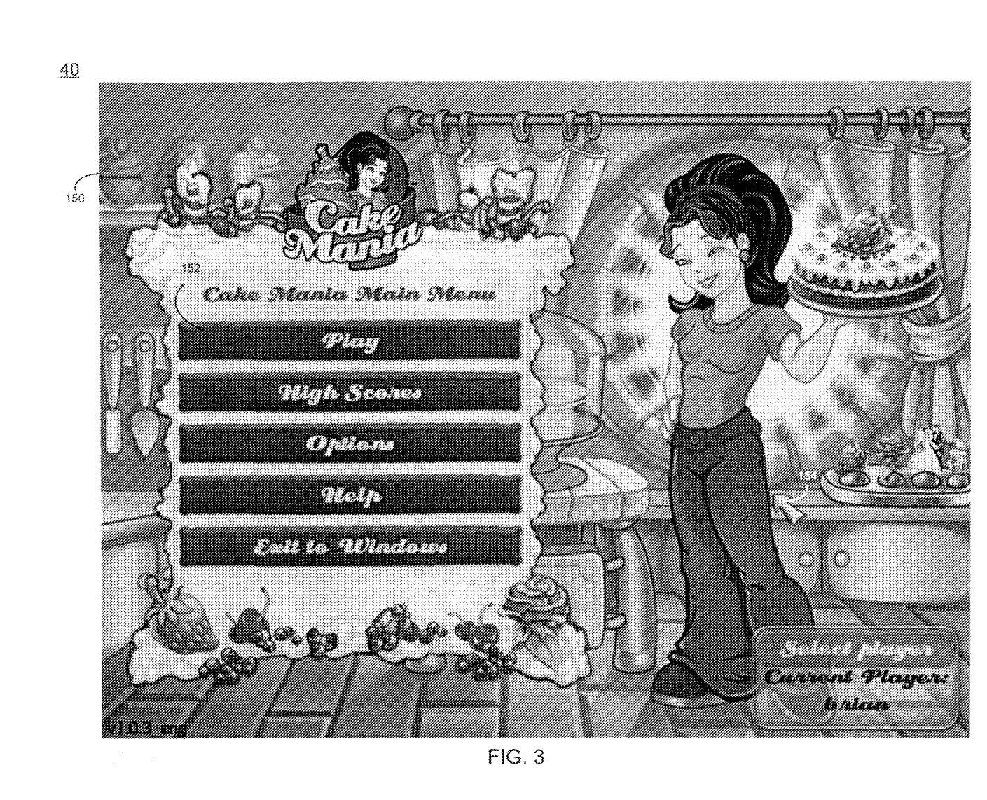

Referring also to FIG. 3, once computer application 40 is loaded, computer application 40 may render introduction screen 150 that allows the user to “Play” gaming computer application 40, view the “High Scores” of gaming computer application 40, set “Options” for gaming computer application 40, get “Help” with gaming computer application 40, and/or “Exit” gaming computer application 40. If user wishes to execute (i.e., play) computer application 40, the user may select “Play” button 152 using onscreen pointer 154 (which is controllable via a pointing device, such as a mouse; not shown).

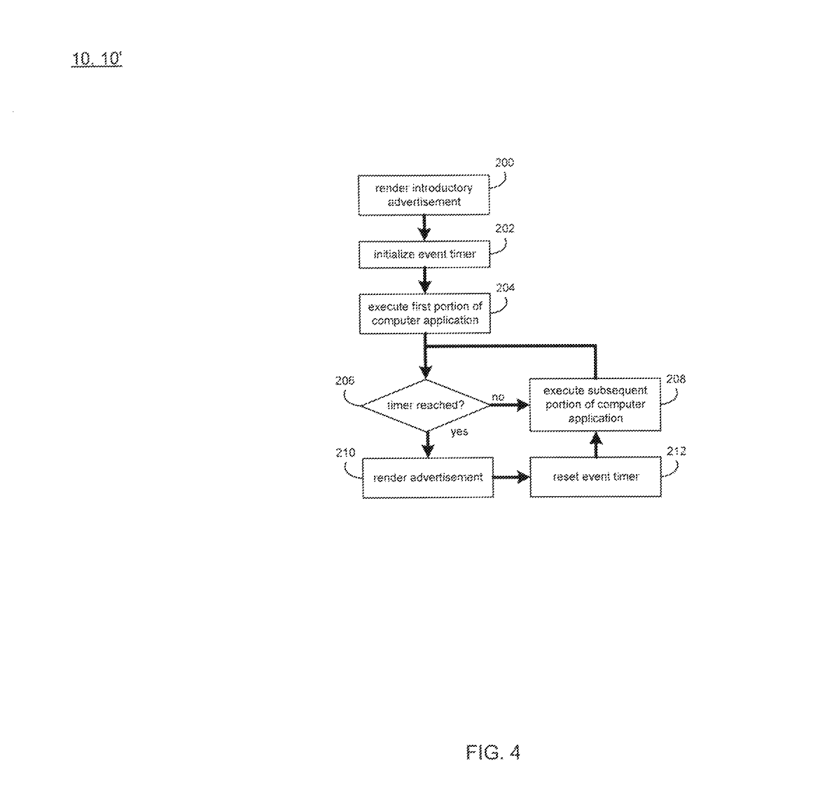

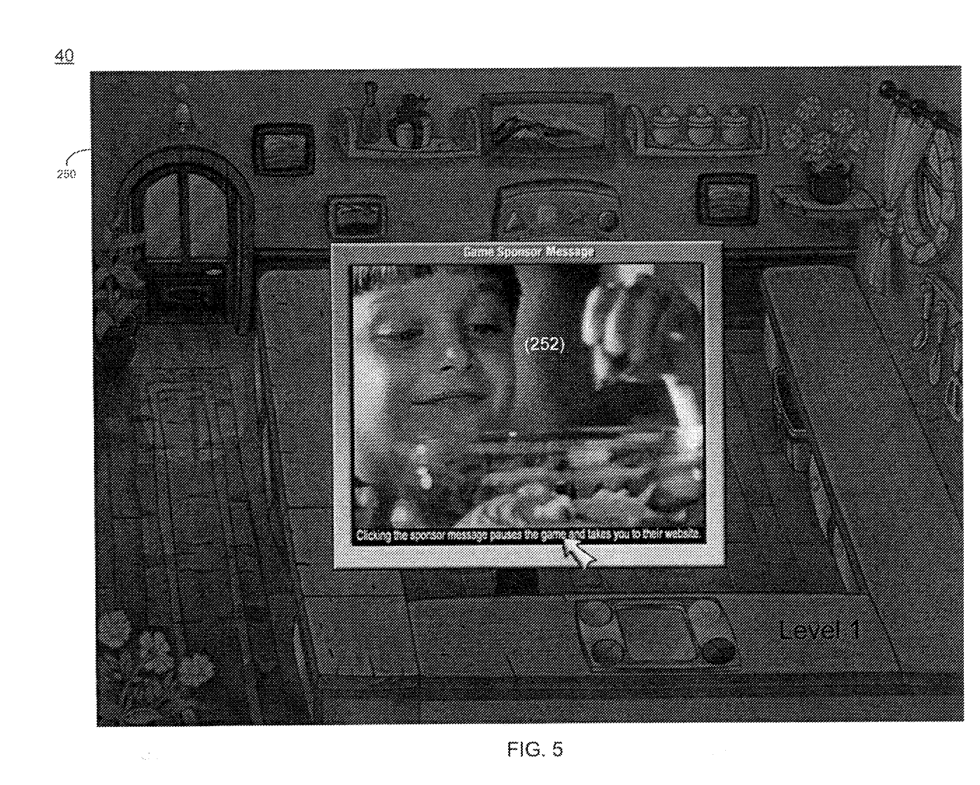

Referring also to FIG. 4, once execution of computer application 40 is initiated, content insertion process 10, 10′ may render 200 an introductory advertisement. For example and referring also to FIG. 5, upon selecting “Play” button 152 (FIG. 3), initial game screen 250 may be rendered by computer application 40 and content insertion process 10, 10′ may render 200 introductory advertisement 252 within e.g., initial game screen 250. When rendering 200 introductory advertisement 252, initial game screen 250 may be shadowed/grayed out to focus the viewer's attention of introductory advertisement 252. Advertisement 252 may be obtained from content distribution system 30 via e.g., network 20 and/or network 28. Examples of advertisement 252 may include but are not limited to a video advertisement; an audio advertisement; and a still image advertisement. Additionally, the intended audience of the computer application 40 may be considered when choosing the content of advertisement 252. For example, if computer application 40 is a gaming computer application that is designed to teach preschool children how to read, an advertisement for Fisher-Price™ toys may be age appropriate . . . while a advertisement for Bacardi™ Rum probably is not age appropriate.

Once introductory advertisement 252 is rendered, content insertion process 10, 10′ may initialize 202 an event timer. The event timer may define the minimum amount of time between advertisements. For example, a typical value for the event timer is ten minutes. Accordingly and once initialized 202, the event timer may be incremented or decremented depending on the manner in which the event timer is configured. For example, if the event timer is initialized 202 to ten minutes, the event timer may be decremented until it reaches zero. Alternatively, if the event timer is initialized 202 to zero, the event timer may be incremented until it reaches ten minutes.

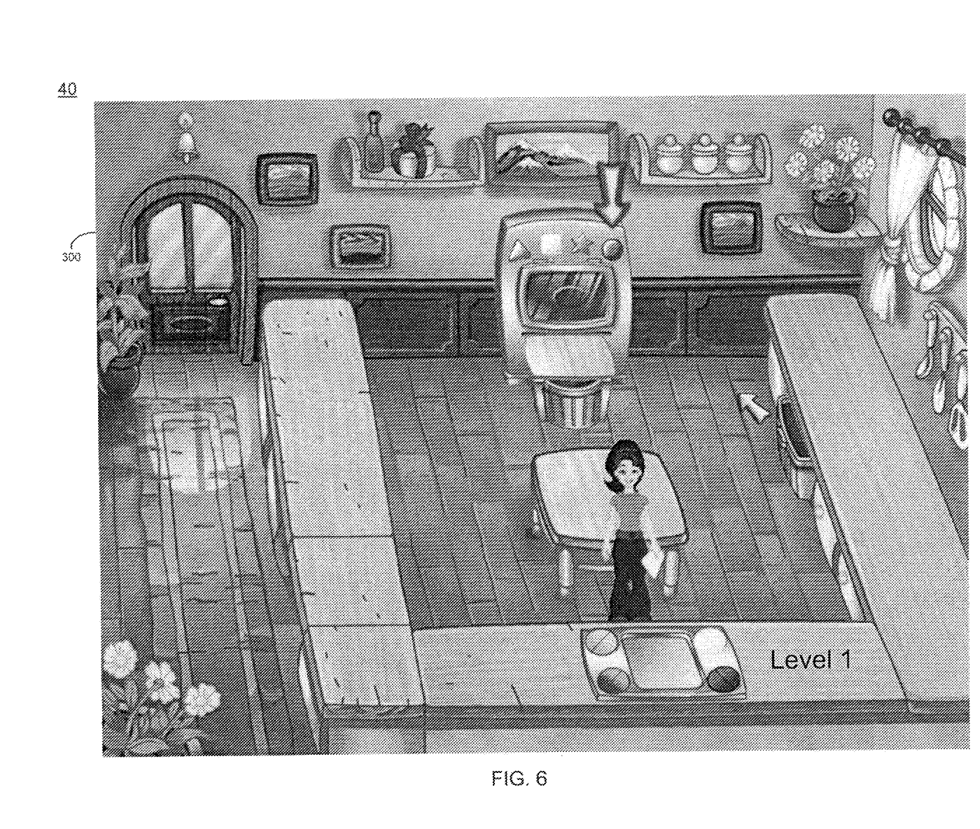

Continuing with the above-stated example and referring also to FIG. 6, once the event timer is initialized 202 by content insertion process 10, 10′, content insertion process 10, 10′ may execute a first portion of computer application 40, which may result in the rendering of gaming screen 300 of computer application 40. Additionally and as discussed above, content insertion process 10, 10′ may increment/decrement the event timer. As discussed above, examples of computer application 40 may include locally-installed gaming/productivity computer applications and/or a web-browsing computer application that allows access to a remotely-installed gaming/productivity computer application.

As discussed above, content insertion process 10, 10′ may execute a first portion of computer application 40. An example of this first portion executed may be a first level (or any level) of a gaming computer application. Other examples may include but are not limited to rendering a defined number of pages of an online article, and allowing a defined amount of typing within a word processor.

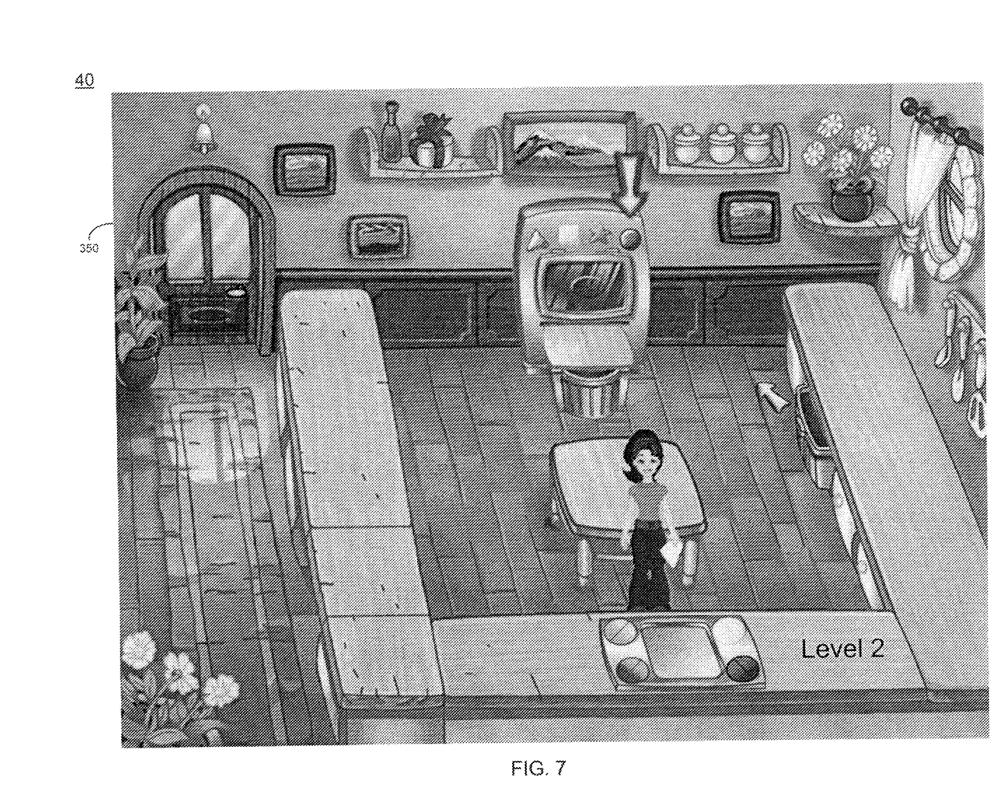

Continuing with the above-stated example, user 32 may play “Level 1” (i.e., the first portion) of computer application 40, during which time content insertion process 10, 10′ is incrementing/decrementing the event timer. Once the first portion (i.e., “Level 1”) of computer application 40 is completed by user 32, content insertion process 10, 10′ may determine 206 if the event timer has reached a predetermined amount (e.g., ten minutes). If the event timer has not reached the predetermined amount, a second portion of the computer application may be executed 208. For example and referring also to FIG. 7, assume that it takes user 32 eight minutes to complete “Level 1” (i.e., as represented by gaming screen 300 of FIG. 6) of computer application 40. Accordingly, once the first portion (i.e., “Level 1”) of computer application 40 is completed by user 32, content insertion process 10, 10′ may determine 206 that the event timer has not reached the predetermined amount (e.g., ten minutes) and content insertion process 10, 10′ may execute a second portion (i.e., as represented by gaming screen 350) of computer application 40.

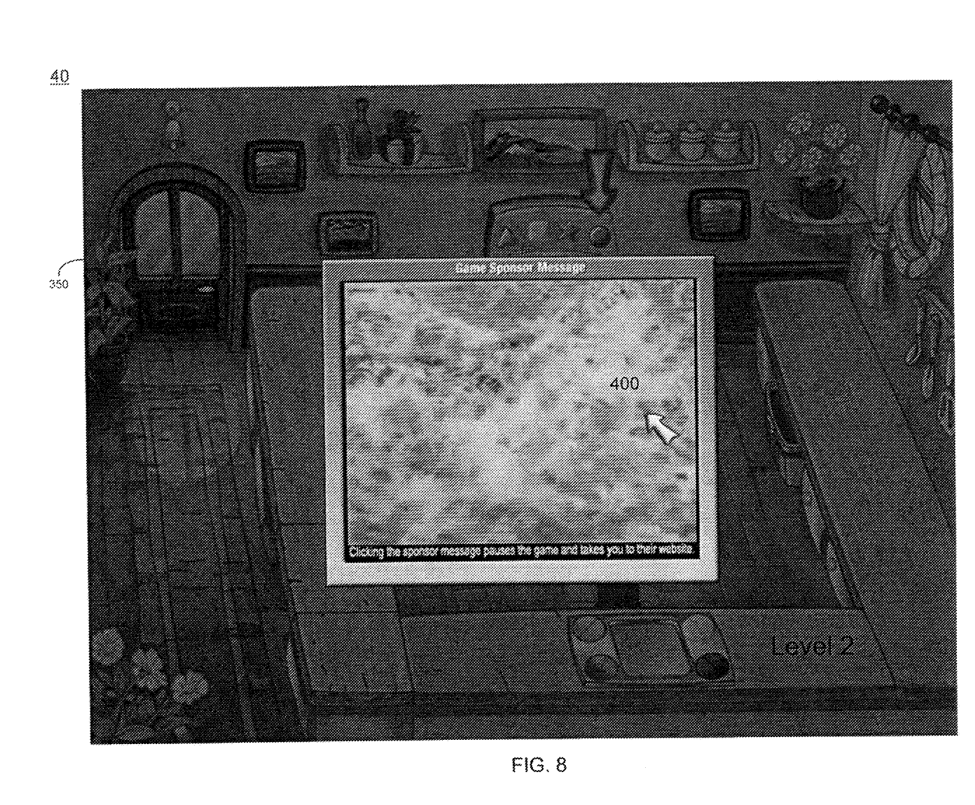

Conversely and referring to FIG. 8, if the event timer has reached the predetermined amount (e.g., 10 minutes), advertisement 400 may be rendered 210 prior to user 32 being allowed to continue to play computer application 40. Advertisement 400 may be obtained from content distribution system 30 via e.g., network 20 and/or network 28. Examples of advertisement 400 may include but are not limited to a video advertisement; an audio advertisement; and a still image advertisement. Additionally and as discussed above, the intended audience of computer application 40 may be considered when choosing the content of advertisement 400.

Continuing with the above stated example, assume that it takes user 32 twelve minutes to complete “Level 1” (i.e., as represented by gaming screen 300 of FIG. 6) of computer application 40. Accordingly, once the first portion (i.e., “Level 1”) of computer application 40 is completed by user 32, content insertion process 10, 10′ may determine 206 that the event timer has reached the predetermined amount (e.g., ten minutes) and content insertion process 10, 10′ may render 210 advertisement 400 prior to user 32 being allowed to continue to advance to the next level (i.e., as represented by gaming screen 350, FIG. 7) of computer application 40. When rendering 210 advertisement 400, gaming screen 350 may be shadowed/grayed out to focus the viewer's attention of advertisement 400.

Once the event timer has reached the predetermined amount (e.g., ten minutes) and content insertion process 10, 10′ has rendered 210 advertisement 400, content insertion process 10, 10′ may reset 212 the event timer and additional portions of computer application 40 may be executed 208. This process of: executing 208 a portion of the computer application; determining 206 if the event timer has reached a predetermined amount; and (if so) rendering 210 an advertisement and resetting 212 the event timer, may be continued until execution of computer application 40 is completed and/or user 32 chooses to stop executing computer application 40.

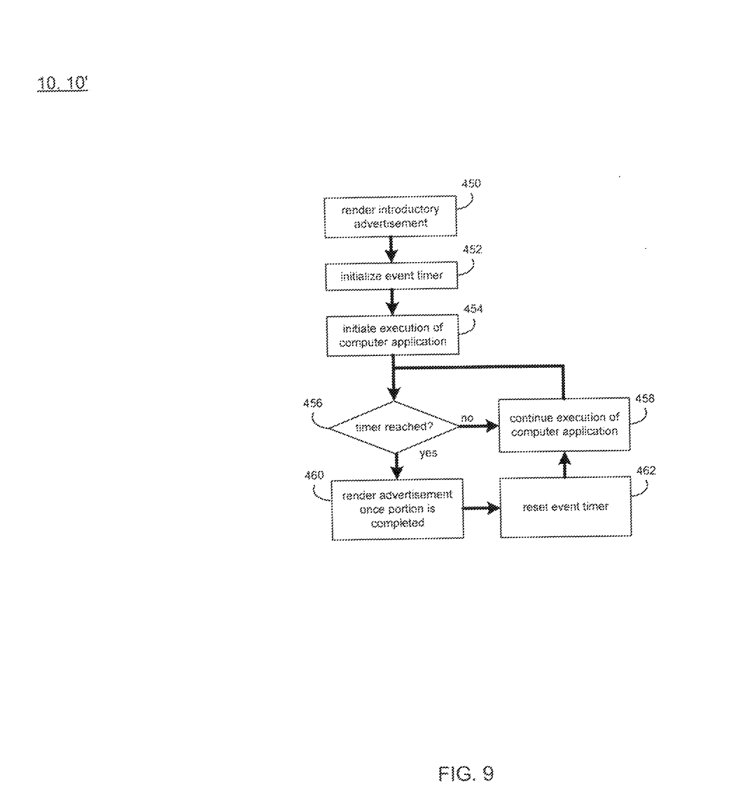

Referring to FIG. 9, there is shown an alternative embodiment of content insertion process 10, 10′. Content insertion process 10, 10′ may render 450 an introductory advertisement (e.g., advertisement 252, FIG. 5) prior to initializing 452 the event timer. Examples of advertisement 252 may include but are not limited to a video advertisement; an audio advertisement; and a still image advertisement. Additionally and as discussed above, the intended audience of computer application 40 may be considered when choosing the content of advertisement 252.

Content insertion process 10, 10′ may initiate execution 454 of computer application 40. As discussed above, computer application 40 may be a multi-portion computer application that includes a plurality of levels. An example of such a multi-portion computer application is the multi-level gaming computer application described above.

As discussed above, while computer application 40 is being executed, the event timer may be either incremented or decremented (depending on the manner in which the event timer is configured). Content insertion process 10, 10′ may monitor the event timer to determine 456 if the event timer has reached a predetermined amount (e.g., ten minutes). Until the event timer reaches the predetermined amount, content insertion process 10, 10′ may continue to execute 458 computer application 40. Accordingly, if user 32 completes “Level 1” (as represented by gaming screen 300 of FIG. 6) prior to the event timer reaching a predetermined amount, content insertion process 10, 10′ may allow user 32 to proceed to “Level 2” (as represented by gaming screen 350 of FIG. 7).

Once the event timer reaches the predetermined amount, content insertion process 10, 10′ may continue to execute computer application 40 until the current portion is completed. For example, assume that when the event timer reaches the predetermined amount, user 32 has not yet completed “Level 1” of computer application 40. Accordingly, content insertion process 10, 10′ may continue executing computer application 40 until the current level (i.e., “Level 1” as represented by gaming screen 300 of FIG. 6) is completed. Once completed, content insertion process 10, 10′ may render 460 advertisement 400 (FIG. 8) prior to user 32 being allowed to continue on to “Level 2” (i.e., as represented by gaming screen 350, FIG. 7) of computer application 40. Examples of advertisement 400 may include but are not limited to a video advertisement; an audio advertisement; and a still image advertisement. Additionally and as discussed above, the intended audience of computer application 40 may be considered when choosing the content of advertisement 400.

Once the event timer has reached the predetermined amount (e.g., ten minutes) and content insertion process 10, 10′ has rendered 460 advertisement 400, content insertion process 10, 10′ may reset 462 the event timer and continue execution 458 of computer application 40. Accordingly, “Level 2” (i.e., as represented by gaming screen 350, FIG. 7) of computer application 40 may be executed 458. This process of: executing 454 a portion of the computer application; determining 456 if the event timer has reached a predetermined amount; and (if so) rendering 460 an advertisement (once the current application portion is completed) and resetting 462 the event timer, may be continued until execution of computer application 40 is completed and/or user 32 chooses to stop executing computer application 40.

While content insertion process 10 is described above as inserting advertisements at various predefined content insertion points during the execution of a computer application, this is for illustrative purposes only and is not intended to be a limitation of this disclosure. For example, content insertion process 10 may insert any type of dynamic content at the above-described content insertion points, examples of which may include but are not limited to: news alerts; weather alerts; personal video messages; and personal audio messages.

A number of implementations have been described. Nevertheless, it will be understood that various modifications may be made. Accordingly, other implementations are within the scope of the following claims.

What is claimed is:

1-40. (canceled)

41. A content distribution apparatus comprising:
at least one data server, including one or more server processors configured to direct operation of the data server;
a first subroutine executable by the one or more server processors to transmit a first portion of a multi-portion gaming computer application to a client device;
a second subroutine executable by the one or more server processors to initialize a server-side event timer in response to an indication via a wireless communication channel that the client device has initiated execution of the first portion of the multi-portion gaming computer application; and
a third subroutine executable by the one or more server processors to transmit at least a first portion of client-device-renderable dynamic content via the wireless communication channel to the client device in response to the server-side event timer reaching a predetermined amount.

42. The content distribution apparatus of claim 41, wherein the second and third subroutines executable by the one or more server processors are components of a server-based application.

43. The content distribution apparatus of claim 41, wherein the second and third subroutines executable by the one or more server processors are components of a hybrid client-side/server-side application.

44. The content distribution apparatus of claim 43, wherein the hybrid client-side/server-side application includes a portion of a client-side content insertion process and a portion of a server-side content insertion process.

45. The content distribution apparatus of claim 43, further comprising the client device, the client device including a client-side content insertion process.

46. The content distribution apparatus of claim 41, wherein the one or more processors are configured to transmit the client-device-renderable dynamic content to the client device, the client device configured to render the client-device-renderable dynamic content after the client device has completed execution of the first portion of the multi-portion gaming computer application.

47. The content distribution apparatus of claim 41, wherein the one or more processors are configured to transmit the client-device-renderable dynamic content via the wireless communication channel to a device configured to execute the multi-portion gaming computer application, being the client device.

48. The content distribution apparatus of claim 41, further comprising the client device, the client device configured to render the client-device-renderable dynamic content after the client device has completed execution of the first portion of the multi-portion gaming computer application.

49. The content distribution apparatus of claim 41, further comprising the client device, the client device configured to execute a web-browsing computer application that allows a user of the client device to access the multi-portion gaming computer application online.

50. The content distribution apparatus of claim 41, further comprising the client device, the client device configured to access the multi-portion gaming computer application, the multi-portion gaming computer application also being a productivity computer application.

51. The content distribution apparatus of claim 41, further comprising a cellular network/bridge coupled to the data server via the internet and configured to establish the wireless communication channel.

52. The content distribution apparatus of claim 41, further comprising a wireless access point configured to establish a secure communication channel between the client device and the wireless access point, the secure communication channel being the wireless communication channel.

53. The content distribution apparatus of claim 41, wherein the client device includes a client-side content insertion process configured to access a content distribution system that includes the second and third subroutines.

54. The content distribution apparatus of claim 41, further comprising a fourth subroutine configured to render an introductory advertisement before the server-side event timer is initialized, the introductory advertising including a selected one or more of an image advertisement, an audio advertisement, or a video advertisement.

55. The content distribution apparatus of claim 41, wherein the server-side event timer is reset in response to an indication via the wireless communication channel that the client device has initiated execution of another portion of the multi-portion gaming computer application and wherein another portion of client-device-renderable dynamic content is transmitted to the client device in response to the server-side event timer reaching the predetermined amount.

56. The content distribution apparatus of claim 41, wherein the server-side content insertion process is configured to execute another portion of the multi-portion gaming computer application while monitoring the server-side event timer to detect the server-side event timer reaching the predetermined amount.

57. The content distribution apparatus of claim 41, wherein a client-side content insertion process is configured to execute the first portion of the multi-portion gaming computer application while monitoring a client-side event timer.

58. The content distribution apparatus of claim 41, wherein the multi-portion gaming computer application includes a first level and a second level, wherein the first level is the first portion of the multi-portion gaming computer application, and wherein the multi-portion gaming computer application allows access to the second level only after the dynamic content has been rendered.

59. The content distribution apparatus of claim 41, wherein the multi-portion gaming computer application includes a first level and a second level, wherein the first level is the first portion of the multi-portion gaming computer application, and wherein a client-side content insertion process is configured to decide whether or not to allow a user of the client device to proceed to the second level in response to a client-side event timer.

60. A non-transitory computer-readable medium that stores computer executable instructions for causing one or more server processors of a data server to perform a content distribution method comprising:
transmitting a first portion of a multi-portion gaming computer application to a client device;
initializing a server-side event timer in response to an indication via a wireless communication channel that the client device has initiated execution of the first portion of the multi-portion gaming computer application; and
transmitting at least a first portion of client-device-renderable dynamic content via the wireless communication channel to the client device in response to the server-side event timer reaching a predetermined amount.

61. The non-transitory computer-readable medium of claim 60, wherein the transmitting at least the first portion of the client-device-renderable dynamic content via the wireless communication channel to the client device in response to the server-side event timer reaching the predetermined amount comprises:
transmitting the client-device-renderable dynamic content via the wireless communication channel to a device configured to execute the multi-portion gaming computer application, being the client device.

62. The non-transitory computer-readable medium of claim 60, wherein the transmitting at least the first portion of the client-device-renderable dynamic content via the wireless communication channel to the client device in response to the server-side event timer reaching the predetermined amount comprises:
establishing the wireless communication channel via a cellular network/bridge coupled to the data server via the internet.

63. The non-transitory computer-readable medium of claim 60, wherein the multi-portion gaming computer application comprises:
a client-side content insertion process configured to access a content distribution system that includes the second and third subroutines.

64. The non-transitory computer-readable medium of claim 60, wherein the content distribution method further comprises:
resetting the server-side event timer in response to an indication via the wireless communication channel that the client device has initiated execution of another portion of the multi-portion gaming computer application and wherein another portion of client-device-renderable dynamic content is transmitted to the client device in response to the server-side event timer reaching the predetermined amount.

65. A content distribution method comprising:
providing at least one data server, including one or more server processors configured to direct operation of the data server;
executing, by the one or more server processors, a first subroutine that includes transmitting a first portion of a multi-portion gaming computer application to a client device;
executing, by the one or more server processors, a second subroutine that includes initializing a server-side event timer in response to an indication via a wireless communication channel that the client device has initiated execution of the first portion of the multi-portion gaming computer application; and
executing, by the one or more server processors, a third subroutine that includes transmitting at least a first portion of client-device-renderable dynamic content via the wireless communication channel to the client device in response to the server-side event timer reaching a predetermined amount.

66. The content distribution method of claim 65, wherein the executing the third subroutine that includes transmitting at least the first portion of the client-device-renderable dynamic content via the wireless communication channel to the client device in response to the server-side event timer reaching the predetermined amount comprises:
transmitting the client-device-renderable dynamic content via the wireless communication channel to a device configured to execute the multi-portion gaming computer application, being the client device.

67. The content distribution method of claim 65, wherein the executing the third subroutine that includes transmitting at least the first portion of the client-device-renderable dynamic content via the wireless communication channel to the client device in response to the server-side event timer reaching the predetermined amount comprises:
establishing the wireless communication channel via a cellular network/bridge coupled to the data server via the internet.

68. The content distribution method of claim 65, further comprising:
configuring a client-side content insertion process to access a content distribution system that includes the second and third subroutines.

69. The content distribution method of claim 65, further comprising:
resetting the server-side event timer in response to an indication via the wireless communication channel that the client device has initiated execution of another portion of the multi-portion gaming computer application and wherein another portion of client-device-renderable dynamic content is transmitted to the client device in response to the server-side event timer reaching the predetermined amount.

70. The content distribution method of claim 65, wherein the multi-portion gaming computer application includes a first level and a second level, wherein the first level is the first portion of the multi-portion gaming computer application, and wherein a client-side content insertion process is configured to decide whether or not to allow a user of the client device to proceed to the second level in response to a client-side event timer.

71. A content distribution method comprising:
receiving, at a client device, a first portion of a multi-portion gaming computer application;
transmitting an indication that the client device has initiated execution of the first portion of the multi-portion gaming computer application via a wireless communication channel to a data server configured to initialize a server-side event timer in response to the indication;
receiving, at the client device, at least a first portion of client-device-renderable dynamic content via the wireless communication channel sent in response to the server-side event timer reaching a predetermined amount; and
rendering, at the client device, at least the first portion of client-device-renderable dynamic content after the client device has completed execution of the first portion of the multi-portion gaming computer application.

72. The content distribution method of claim 71, wherein the rendering at least the first portion of client-device-renderable dynamic content after the client device has completed execution of the first portion of the multi-portion gaming computer application comprises:
executing the multi-portion gaming computer application until a first level is complete, the first level being the first portion of the multi-portion gaming computer application;
rendering an advertisement once the first level of the multi-portion gaming computer application is complete, the advertisement including a selected one or more of an image advertisement, an audio advertisement, or a video advertisement; and
after rendering the advertisement, executing a second level of the multi-portion gaming computer application.

73. The content distribution method of claim 71, wherein the rendering at least the first portion of client-device-renderable dynamic content after the client device has completed execution of the first portion of the multi-portion gaming computer application comprises:
determining that a client-side event timer has reached the predetermined amount while executing the first portion of the computer application;
rendering an advertisement once the first portion of the multi-portion gaming computer application is completed and after the client-side event timer has reached the predetermined amount, the advertisement including the first portion of the client-device-renderable dynamic content; and
resetting the client-side event timer.
